(19) United States
(12) Patent Application Publication
(10) Pub. No.: US 2004/0190463 A1
(43) Pub. Date: Sep. 30, 2004

(54) Change-over apparatus

(76) Inventor: Genichi Imamura, Kanagawa (JP)

Correspondence Address: FISH & RICHARDSON P.C., 1425 K STREET, N.W., 11TH FLOOR, WASHINGTON, DC, 20005-3500, US

(21) Appl. No.: 10/810,805

(22) Filed: Mar. 29, 2004

(30) Foreign Application Priority Data
Mar. 31, 2003 (JP) 94757/2003

(51) Int. Cl. H04L 5/14

(52) U.S. Cl. 370/276; 370/332

(57) ABSTRACT

A change-over apparatus is suitable for improving the reliability of a duplex system. The change-over apparatus is associated with a duplex system which includes a pair of devices, i.e., a main device and a backup device. The change-over apparatus comprises a switch and a switching controller. The switching controller comprises a first monitor and a second monitor, each of which has a digital monitoring circuit for monitoring a signal associated with the duplex system from a digital signal aspect. Each of the monitors can also comprise an analog monitoring circuit for monitoring the signal from an analog signal aspect. A switching command circuit switches between the pair of devices based on signals from the first and second monitors.

### BACKGROUND OF THE INVENTION

The present invention relates to the field of duplex system, and more particularly, to a change-over apparatus suitable for use in a duplex system.

Conventionally, a change-over unit is used for a duplex system, for example, in a broadcasting station. The change-over unit is configured to monitor the level of a signal from each of two devices belonging to two lines in the duplex system. When the signal level decreases below a predetermined threshold, the change-over unit determines a fault or anomaly in a device associated with the signal level. With such a configuration, the change-over unit immediately switches from a failed device to a backup device to ensure that the duplexed device operates without interruption.

Currently, however, broadcasting stations employ a digital signal such as a serial digital interface (SDI) signal. In this case, even if an SDI signal does not present, for example, an unusual signal level, data represented by the signal can be faulty. The “data fault” used herein refers to a deviation from the standard related to the SDI signal, and includes a faulty sequence of data, faulty data indicative of the level, and the like. With such faulty data, the conventional change-over unit is incapable of detecting such a fault or anomaly and therefore is incapable of accommodating the fault.

Similar problems to the above may occur in a system used in systems other than those of broadcasting stations. For example, a computer system in a duplex configuration may suffer from similar problems.

### SUMMARY OF THE INVENTION

It is therefore an object of the present invention to provide a change-over method and apparatus which is suitable for improving the reliability of a duplex system.

It is another object of the present invention to provide a change-over method and apparatus which is suitable for use in a duplex system which handles digital signals.

It is a further object of the present invention to provide a signal change-over method and apparatus which comprises both a digital monitoring function and an analog monitoring function.

It is a further object of the present invention to provide a signal change-over method and apparatus which is suitable for use in a duplex system in a broadcasting station.

It is a further object of the present invention to provide a duplex system which comprises a change-over apparatus as mentioned above.

According to an aspect of the present invention, it is provided a change-over apparatus for use with a duplex system including a pair of devices. The change-over apparatus switches between the pair of devices based on digital monitoring for monitoring a signal associated with the duplex system from a digital signal aspect.

According to an aspect of the present invention, the change-over apparatus may further operate based on analog monitoring for monitoring the signal associated with the duplex system from an analog signal aspect. The change-over apparatus may also operate based on one or both of the digital monitoring and the analog monitoring. Further, the digital monitoring and the analog monitoring may include monitoring related to standards associated with the duplex system.

Also, according to an aspect of the present invention, the digital signal aspect may include an aspect of data represented by a digital signal. The analog signal aspect may include the level of a signal.

Further, according to an aspect of the present invention, the duplex system may be associated with a broadcasting system. Each of the devices may be a reference signal generator for the broadcasting system. The signal associated with the duplex system may be a serial digital interface (SDI) signal.

The present invention also provides a duplex system which includes the change-over apparatus described above.

The present invention further provides a signal change-over circuit for switching between two signals. The signal change-over circuit performs a signal change-over function based on digital monitoring for monitoring the signals from a digital signal aspect.

According to an aspect of the present invention, the signal change-over circuit may further operate based on analog monitoring for monitoring the signals from an analog signal aspect. Also, the signal change-over circuit may operate based on one or both of the digital monitoring and the analog monitoring. The digital monitoring and analog monitoring may include monitoring related to standards associated with the signals.

Also, according to an aspect of the present invention, the signal change-over circuit may be associated with a duplex system including a pair of devices. In this event, the duplex system may be associated with a broadcasting system. The two signals may be output signals from the respective devices of the duplex system.

Further according to an aspect of the present invention, the signal change-over circuit may include a switch switching between the two signals, and a switching controller controlling the switching of the switch. The switching controller may include a monitor monitoring one or both of the two signals, and performing the digital monitoring. The switch may include a first and a second input terminal for receiving the two signals, respectively, and an output terminal for outputting one of the two signals. The monitor may include a first and a second monitors, and each of the monitors may include a digital monitoring circuit performing the digital monitoring, and an analog monitoring circuit performing the analog monitoring.

### BRIEF DESCRIPTION OF THE DRAWINGS

FIG. 1 is a block diagram illustrating a duplex system which is configured in accordance with the present invention;

FIG. 2 is a block diagram illustrating in detail the circuit configuration of a change-over unit in FIG. 1 according to an embodiment of the present invention;

FIG. 3 is a block diagram illustrating in greater detail the circuit configuration of a digital monitoring circuit in FIG. 2 according to an embodiment of the present invention; and

FIG. 4 is a block diagram illustrating in greater detail the circuit configuration of an analog monitoring circuit in FIG. 2 according to an embodiment of the present invention.

### DETAILED DESCRIPTION OF THE EMBODIMENTS

In the following, certain embodiments of the present invention will be described in detail with reference to the accompanying drawings.

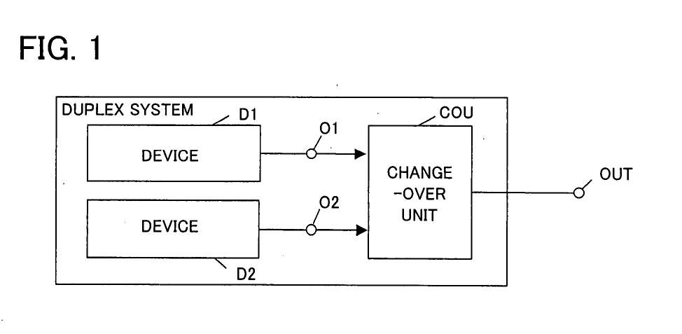

FIG. 1 is a block diagram of a duplex system which is configured in accordance with the present invention. As illustrated, the duplex system comprises a pair of devices D1 and D2, and a change-over unit COU which is configured in accordance with the present invention. The devices D1 and D2 are identical to each other, and function such that one of them, for example D1, functions as a main device, while the other, for example, D2 functions as a backup device. These devices D1 and D2 supply device outputs at their output terminals O1 and O2, respectively. The change-over unit COU has two input terminals connected to the output terminals O1 and O2 of the devices D1 and D2, respectively, and has a function of connecting one of the two input terminals to an output terminal OUT. The change-over unit COU also has a function of monitoring the devices D1 and D2 for acquiring control information for the change-over operation.

The devices D1 and D2 are monitored by monitoring signals associated with the respective devices. The signals associated with the devices may be the output signals of the respective devices, by way of example, but may be internal signals within the devices indicative of the states of the devices. Based on the result of such monitoring, the change-over unit COU changes over from the main device D1 to the backup device D2 when it finds a fault in the main device D1, thereby disconnecting the output of the main device D1 from the output terminal OUT of the change-over unit COU and connecting the output of the backup device D2 to the output terminal OUT. In this way, the duplex system carries out a fail-safe function. Such a duplex system is employed in a field in which the fail-safe function is required, for example, in a broadcasting station in which no interruption is permitted in the broadcasting or operations, and in a variety of systems which employ computers. Also, in a broadcasting system in a broadcasting station, the foregoing duplexed device may be exemplified by a reference signal generator for generating a standard color bar signal, a synchronization signal, or the like.

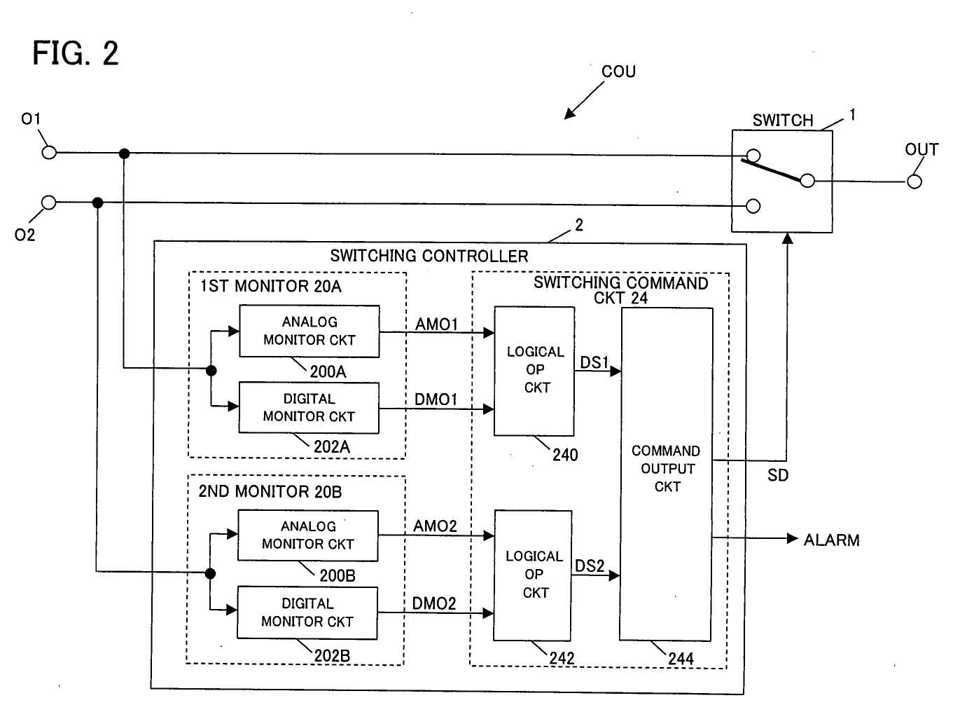

Next, FIG. 2 illustrates in detail an embodiment of the change-over unit COU in FIG. 1. As illustrated, the change-over unit COU comprises a switch 1, and a switching controller 2. The switch 1 has two input terminals connected to the outputs O1 and O2 of the devices D1 and D2, respectively, and an output terminal connected to the output terminal OUT of the duplex system. The switch 1 also has a control input for receiving a signal for switching. The switch 1 can be implemented, for example, by a relay or a semiconductor switch. Next, the switching controller 2 comprises a first monitor 20A, a second monitor 20B, and a switching command circuit 24.

The first monitor 20A has an input terminal connected to the output O1 of the main device D1, while the second monitor 20B has an input terminal connected to the output O2 of the backup device D2. The first monitor 20A and second monitor 20B are identical in configuration, and comprise an analog monitoring circuit 200A or 200B, and a digital monitoring circuit 202A or 202B, respectively. These monitoring circuits perform a monitoring function for signals received from output terminals of associated devices, and generate at their respective output terminals analog monitoring output signals AMO1 and AMO2 and digital monitoring signals DMO1 and DMO2 which are indicative of the results of the respective monitoring. Each of the analog monitoring circuits 200A and 200B monitors an analog signal aspect of signals delivered from the associated device. The “analog signal aspect” used herein includes parameters associated with analog signals, for example, magnitude, level, amplitude, positive or negative peak value, frequency, and the like. Particular parameters of an analog signal under monitoring are determined depending on the specifications and/or standard which should be satisfied by the device output signal. It should be noted that even a digital signal also has an aspect of analog signal, so that the “analog signal aspect” also includes analog signal parameters associated with a digital signal. Each of the digital monitoring circuits 202A and 202B in turn monitors a digital signal aspect of the device output signal. The “digital signal aspect” used herein includes parameters associated with digital signals; for example, a variety of error detecting techniques, errors under the error correcting techniques, contents represented by data included in digital signals, and the like. Likewise, particular parameters of a digital signal under monitoring are determined depending on the specifications and or standard which should be satisfied by the device output signal. In this way, each monitoring circuit generates a signal indicative of a fault or anomaly at its output terminal when it determines in accordance with the result of monitoring that a fault occurs. Additionally, a signal indicative of the type of fault may be included if necessary.

Next, the switching command circuit 24 connected to the outputs of the respective monitoring circuits comprises two logical operation circuits 240 and 242, and a command output circuit 244. More specifically, the upper logical operation circuit 240 has two input terminals connected to the outputs of the analog monitoring circuit 200A and digital monitoring circuit 202A in the first monitor 20A, respectively, and also has an output terminal for delivering a device state signal DS1 which is the result of a logical operation performed on the two received input signals, i.e., the analog monitoring output signal AMO1 and digital monitoring output signal DMO1. The logical operation circuit 240 performs a logical OR operation of the two input signals AMO1 and DMO1. In this way, the logical operation circuit 240 generates the device state signal DS1 indicative of a fault in the main device D1 at its output terminal when at least one of an analog signal fault or a digital signal fault occurs. The lower logical operation circuit 242, which is identical to the logical operation circuit 240 in configuration, performs a logical OR operation of the analog monitoring output signal AMO2 from the circuit 200B and the digital monitoring output signal DMO2 from the circuit 202B, and generates a backup device state signal DS2 indicative of the result of the logical OR operation at its output terminal. While the logical operation circuits perform a logical OR operation in the foregoing description, a logical AND operation or another arbitrary logical operation may be performed alternatively or additionally as the case may be, whereby the device change-over control can be conducted in greater detail or based on more conditions or factors.

Then, the command output circuit 244 has two input terminals for receiving the device state signals DS1 and DS2 from the logical operation circuits 240 and 242, respectively, forms a switching drive signal SD based on the received device state signals DS1 and DS2, and supplies the switching drive signal SD to the control input terminal of the switch 1. The command output circuit 244 may also comprise an alarm output terminal connected to a lamp, LED, buzzer, or the like (not shown) for alarming. The command output circuit 244 may be implemented by a combination of conventional logic circuits and a conventional driving circuit.

With the foregoing configuration, the command output circuit 244 is responsive when one of the two device state signals (for example, DS1) goes high, for example, indicating a fault or anomaly in one of the devices D1 or D2 (for example, device D1), and when the other device state signal (for example, DS2) is at low, indicating a normal state, to generate the switching drive signal SD for switching the switch 1 to connect the other device D2 to the output terminal OUT. Also, when it is revealed that the currently used main device D1 is normal, whereas the backup device D2 is faulty, the command output circuit 244 generates an alarm sound, alarm display, or the like, indicative of the fault in the backup device D2, to a system operator through the alarm output. Likewise, when a fault in the main device D1 causes a change-over to the backup device D2, such an alarm sound, alarm display, or the like can be generated for indicating the fault in the main device D1.

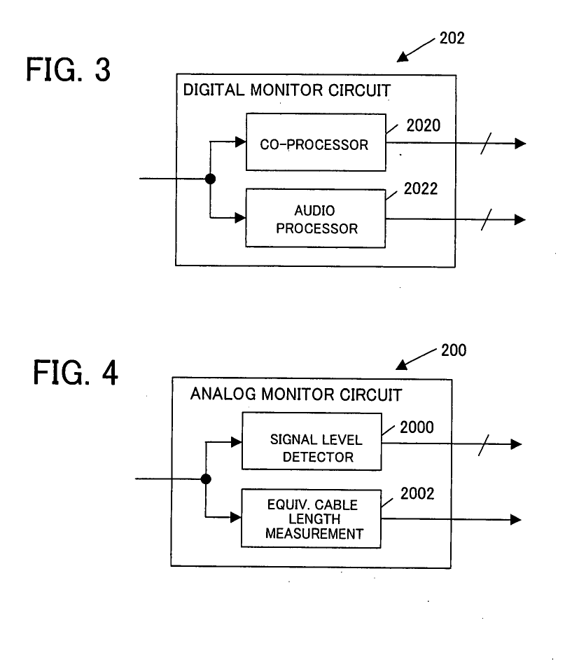

Referring next to FIG. 3, an embodiment of the digital monitoring circuit 202 will be described in greater detail in terms of the circuit configuration. As illustrated, the digital monitoring circuit 202 comprises a co-processor 2020, and an audio processor 2022. Each of the co-processor 2020 and audio processor 2022 has one input terminal for receiving a device output signal from an associated device, and at least one output terminal for generating a digital monitoring signal for the received device output signal. These output terminals lead to the digital monitoring output DMO of the digital monitoring circuit 202 in FIG. 2.

More specifically, the co-processor 2020 monitors video signals, and may be implemented, for example, by HDTV serial digital deformatter GS1500 made by GENNUM Corporation. Details of the deformatter are described in data sheet on GS 1500 of GENNUM Corporation (DATA SHEET, Revision Date: July 2002, Document No. 52233-3), the contents of which are incorporated herein by reference. The co-processor 2020 monitors a TRS (time reference signal) error, a line number error (for detecting errors in video signals), a CRC error (or data sequence error), an EDH error, a reserved error (for detecting errors in reserved data), a parity error (for detecting parity errors in ancillary data), a check sum error (for detecting check sum errors in ancillary data), and the like for HD (High Definition) and SD (Standard Definition) SDI signals based on the broadcasting standards SMPTE274M, 296M, 259M, 125M, 296M, 293M, or the like. The audio processor 2022 in turn monitors audio signals, and may be implemented, by way of example, by an audio demultiplexer, for example, GS1503 made by GENNUM Corporation. Details on GS1503 are described in data sheet on GS1503 of GENNUM Corporation (DATA SHEET, Revision Date: September 2003, Document No. 15879-2), the contents of which are incorporated herein by reference. The audio processor 2022 monitors a BCH (Bose Chaudhuri Hocquenghem) error (for detecting audio errors), and an audio continuity error (for detecting audio discontinuities). In this way, each of the co-processor 2020 and audio processor 2022 monitors a variety of errors, and generates a signal indicative of a detected error at the output terminal upon detection of one or more errors. Since the circuit of this embodiment can detect a plurality of errors, the subsequent logical operation circuit performs a logical OR operation to determine a fault in the digital signal aspect when at least one error occurs. Details on the aforementioned standards are described in the respective standard documents.

Next, FIG. 4 illustrates in detail the circuit configuration of the analog monitoring circuit 200 in an embodiment of the present invention. As illustrated, the analog monitoring circuit 200 comprises a signal level detector 2000, and an equivalent cable length measuring circuit 2002, each of which has an input terminal for receiving a device output signal from an associated device, and at least one output terminal for generating an analog monitoring signal. More specifically, the signal level detector 2000 is similar in circuit configuration to a signal level detector circuit in a conventional change-over unit, and one example of the signal level detector 2000 is described in Instruction Manual 071-0859-00 of EC0422D SD/HD change-over unit made by Tektronix Inc., the contents of which are incorporated herein by reference. As before, the signal level detector 2000 comprises, for example, an input buffer, a peak detector, and a comparator. The comparator has at least one threshold, and compares a detected peak value from the peak detector with a threshold selected for the peak value to determine the occurrence of a fault when the result of the comparison detects a peak value below or above the threshold. Upon detection of such a fault, the detector 2000 generates a signal indicative of the fault at its output terminal. Monitored by the detector 2000 may be, for example, the signal level of each of an HD-SDI signal, an SD-SDI signal, analog sync (NTSC), analog sync (HD three-valued), AES/EBU audio based on the broadcasting standards SMPTE292M, 259M, 170M, 240M, AES-3/EBU Tech 3250. Details on these signals are described in the respective standards associated therewith. The equivalent cable length measuring circuit 2002, which determines a transmission margin for an SDI signal, measures the signal strength of an SDI signal, and generates a signal indicative of a fault at its output terminal when the signal strength falls below a certain threshold. In this embodiment, since a single analog monitoring circuit can detect a plurality of errors, the subsequent logical operation circuit performs a logical OR operation to determine the occurrence of a fault in the analog signal aspect when at least one error occurs. Details on a method of evaluating a digital transmission system, performed in the equivalent cable length measuring circuit 2002, are described in Japanese Patent Application Public-Disclosure No. 7-231336 or corresponding U.S. Pat. No. 5,768,312 issued to Imamura on Jun. 16, 1998, the contents of which are incorporated herein by reference.

According to the present invention described above, the change-over function can be actuated not only in response to a fault or anomaly in the analog signal aspect such as the signal level, but also in response to a fault or anomaly in the digital signal aspect such as erroneous data in signals associated with a duplex system. Consequently, the fail-safe function can be applied to a larger range to further improve the safety of the system.

What is claimed is:

1. A change-over apparatus for a duplex system including a pair of devices, wherein said change-over apparatus switches between said pair of devices based on digital monitoring for monitoring a signal associated with said duplex system from a digital signal aspect.

2. A change-over apparatus according to claim 1, wherein said change-over apparatus further operates based on analog monitoring for monitoring the signal associated with said duplex system from an analog signal aspect.

3. A change-over apparatus according to claim 2, wherein said change-over apparatus operates based on one or both of said digital monitoring and said analog monitoring.

4. A change-over apparatus according to claim 2, wherein said digital monitoring and said analog monitoring include monitoring related to standards associated with said duplex system.

5. A change-over apparatus according to claim 2, wherein said digital signal aspect includes an aspect of data represented by a digital signal.

6. A change-over apparatus according to claim 2, wherein said analog signal aspect includes the level of a signal.

7. A change-over apparatus according to claim 1, wherein said duplex system is associated with a broadcasting system.

8. A change-over apparatus according to claim 7, wherein each of said devices is a reference signal generator for said broadcasting system.

9. A change-over apparatus according to claim 7, wherein said signal associated with said duplex system is a serial digital interface (SDI) signal.

10. A change-over apparatus according to claim 1, wherein said signal associated with said duplex system is an output signal from each of said devices.

11. A duplex system comprising the change-over apparatus according to claim 1.

12. A signal change-over circuit for switching between two signals, wherein said signal change-over circuit performs a signal change-over function based on digital monitoring for monitoring said signals from a digital signal aspect.

13. A signal change-over circuit according to claim 12, wherein said signal change-over circuit further operates based on analog monitoring for monitoring said signals from an analog signal aspect.

14. A signal change-over circuit according to claim 13, wherein said signal change-over circuit operates based on one or both of said digital monitoring and said analog monitoring.

15. A signal change-over circuit according to claim 13, wherein said digital monitoring and said analog monitoring include monitoring related to standards associated with said signals.

16. A signal change-over circuit according to claim 12, wherein said signal change-over circuit is associated with a duplex system including a pair of devices.

17. A signal change-over circuit according to claim 16, wherein said duplex system is associated with a broadcasting system.

18. A signal change-over circuit according to claim 16, wherein said two signals are output signals from said respective devices of said duplex system.

19. A signal change-over circuit according to claim 12, comprising:
a switch switching between said two signals; and
a switching controller controlling the switching of said switch, said switching controller including a monitor monitoring one or both of said two signals, said monitor performing said digital monitoring.

20. A signal change-over circuit according to claim 19, wherein:
said switch includes a first and a second input terminal for receiving said two signals, respectively, and an output terminal for outputting one of said two signals.

21. A signal change-over circuit according to claim 19, wherein:
said monitor includes a first and a second monitor, wherein:
each of said first and second monitors includes a digital monitoring circuit performing said digital monitoring, and an analog monitoring circuit performing said analog monitoring.

22. A signal change-over circuit comprising:
means for switching between two signals; and
means for controlling the switching of said means for switching, said means for controlling including means for monitoring one or both of said two signals from a digital signal aspect.
